(19) United States
(12) Patent Application Publication
(10) Pub. No.: US 2013/0195219 A1
(43) Pub. Date: Aug. 1, 2013

(54) MOBILE WIRELESS COMMUNICATIONS DEVICE WITH SELECTIVE POWER AMPLIFIER CONTROL AND RELATED METHODS

(71) Applicants: Sivakaran Vinayagamoorthy, Kitchener (CA); Sivanesan Tulasidas, Markham (CA)

(72) Inventors: Sivakaran Vinayagamoorthy, Kitchener (CA); Sivanesan Tulasidas, Markham (CA)

(73) Assignee: Research In Motion Limited, Waterloo (CA)

(21) Appl. No.: 13/359,806

(22) Filed: Jan. 27, 2012

(51) Int. Cl. H04B 1/04; H04B 15/00

(52) U.S. Cl. 375/297

(57) ABSTRACT

A mobile wireless communications device may include a processor, a modulator coupled downstream from the processor, a power amplifier coupled downstream from the modulator and having a control voltage input, an antenna coupled downstream from the power amplifier, and a feedback path coupled between the antenna and the processor. The processor may be coupled to the control voltage input of the power amplifier, and may be configured to determine an adjacent channel leakage value based upon the feedback path and to selectively set a control voltage for the power amplifier based upon the adjacent channel leakage value.

### TECHNICAL FIELD

This application relates to the field of communications, and more particularly, to wireless communications systems and related methods.

### BACKGROUND

Cellular communication systems continue to grow in popularity and have become an integral part of both personal and business communications. Cellular telephones allow users to place and receive phone calls almost anywhere they travel. Moreover, as cellular telephone technology is advanced, so too has the functionality of cellular devices. For example, many cellular devices now incorporate Personal Digital Assistant (PDA) features such as calendars, address books, task lists, calculators, memo and writing programs, etc. These multi-function devices usually allow users to wirelessly send and receive electronic mail (email) messages and access the internet via a cellular network and/or a wireless local area network (WLAN), for example.

Cellular devices have radio frequency (RF) processing circuits and receive or transmit radio communications signals typically using modulation schemes. The typical cellular device may have multiple transmit and receive pathways from the antenna to a digital signal processor (DSP), each transmit path comprising power amplifier drawing power from a battery. In code division multiple access (CDMA), wideband code division multiple access (W-CDMA), and LTE cellular devices, one of the major contributors of battery power consumption is the linear power amplifier. Several approaches may be used to optimize the power amplifier's efficiency under different operating conditions, such as output power level, peak to average power ratio (PAPR) of the signal, temperature and frequency channel, while meeting adjacent channel leakage ratio (ACLR) targets associated with 3GPP/3GPP2.

One approach may include changing the power amplifier supply voltage based upon power amplifier operating conditions. Typically, the changes are based upon a static or factory calibrated lookup tables, where some parameters are characterized with worst case samples and some parameters are individually calibrated during design and manufacture. A potential drawback to this approach may be that the calibration of the individual power amplifier is time consuming and that it is done with static load conditions, i.e. a 50 Ohm environment where actual operation is a live air condition non-50 Ohm load.

### BRIEF DESCRIPTION OF THE DRAWINGS

FIG. 1 is a schematic block diagram of an example embodiment of a mobile wireless communications device.

FIG. 2 is a detailed schematic block diagram of an example embodiment of a mobile wireless communications device

FIG. 3 is a schematic block diagram of an example embodiment of a modulator from the mobile wireless communications device of FIG. 1.

FIG. 4 is a flowchart illustrating operation of the mobile wireless communications device of FIG. 1.

FIG. 5 is a schematic block diagram illustrating example components of a mobile wireless communications device that may be used with the mobile wireless communications device of FIG. 1.

### DETAILED DESCRIPTION OF THE PREFERRED EMBODIMENTS

The present description is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout.

Generally speaking, a mobile wireless communications device may include a processor, a modulator coupled downstream from the processor, a power amplifier coupled downstream from the modulator and having a control voltage input, an antenna coupled downstream from the power amplifier, and a feedback path coupled between the transmit path prior to antenna and the processor. The processor may be coupled to the control voltage input of the switch mode power supply supplying dc power to power amplifier, and may be configured to determine an adjacent channel leakage value based upon the feedback path and to selectively set a supply voltage for the power amplifier via switch mode power supply and input power to the power amplifier based upon the adjacent channel leakage value. Example mobile wireless communications devices may include portable or personal media players (e.g., music or MP3 players, video players, etc.), remote controls (e.g., television or stereo remotes, etc.), portable gaming devices, portable or mobile telephones, smartphones, tablet computers, etc.

In some embodiments, the processor may be configured to selectively set the control voltage for the power amplifier based upon a received power control value. More specifically, the processor may be configured to generate the adjacent channel leakage value to comprise an adjacent channel leakage ratio (ACLR) value.

For example, the processor may be configured to selectively set the control voltage to comprise a drain/collector bias voltage for the power amplifier. The mobile wireless communications device may further comprise a power supply cooperating with the processor and configured to selectively generate the control and/or supply voltage to the power amplifier.

Additionally, the modulator may comprise In-phase (I) and Quadrature (Q) transmit circuits coupled between the processor and the power amplifier. Each of the I and Q transmit circuits may comprise a digital-to-analog converter (DAC), a low pass filter coupled to an output of the DAC, and a mixer coupled to an output of the low pass filter. The feedback path may comprises a directional coupler coupled upstream of the antenna, I and Q receive circuits coupled downstream from the directional coupler, and a fast Fourier transform (FFT) block coupled downstream from the I and Q receive circuits.

The mobile wireless communications device may further comprise a variable gain amplifier coupled downstream from directional coupler. The mobile wireless communications device may further comprise an oscillator configured to generate a local oscillator signal, and the I and Q transmit and receive circuits may be configured to operate based upon the local oscillator signal. The mobile wireless communications device may further comprise a variable gain pre-power amplifier coupled downstream from the directional coupler, and a phase shifter block coupled between the local oscillator and said I and Q receive circuits. In some embodiments, the processor may be configured to selectively operate the I and Q receive circuits in a power save mode.

Another aspect is directed to a method of operating a mobile wireless communications device comprising a processor, a modulator coupled downstream from the processor, a power amplifier coupled downstream from the modulator and having a control voltage input, an antenna coupled downstream from the power amplifier, and a feedback path coupled between the antenna and the processor. The method may include determining an adjacent channel leakage value based upon the feedback path, and selectively setting a control voltage for the power amplifier based upon the adjacent channel leakage value.

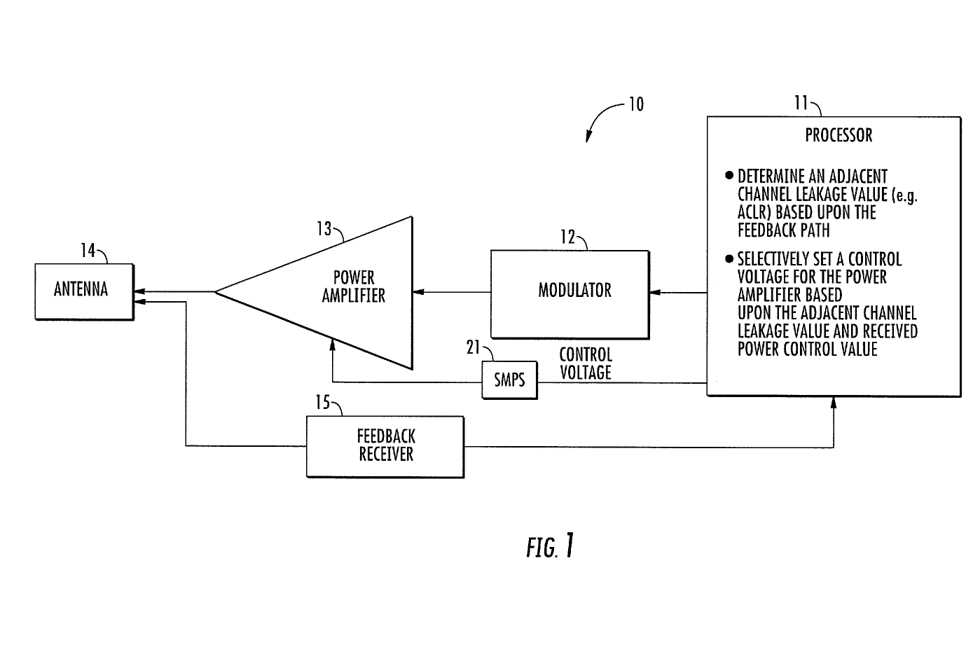

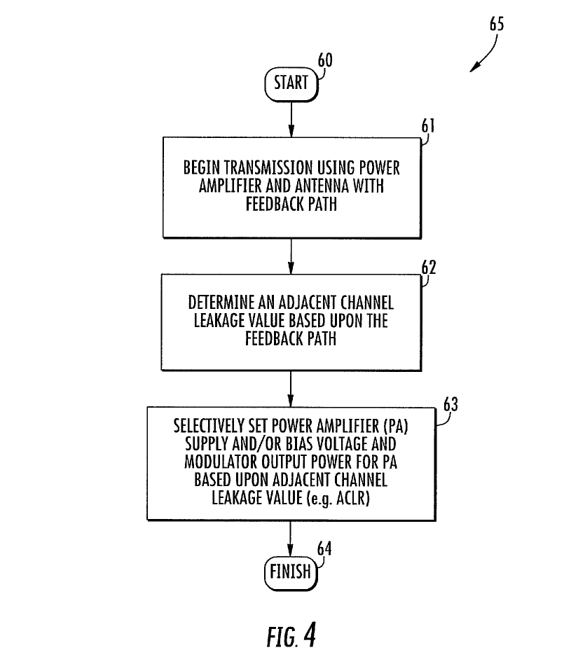

Referring now to FIG. 1, a mobile wireless communications device 10 according to the present disclosure is now described. Moreover, with reference additionally to FIG. 4, a flowchart 65 illustrates a method of operating the mobile wireless communications device 10 (Block 60). The mobile wireless communications device 10 illustratively includes a processor 11, a modulator 12 coupled downstream from the processor, a power amplifier 13 coupled downstream from the modulator and having a control voltage input, an antenna 14 coupled downstream from the power amplifier, and a feedback receiver 15 coupled between the antenna and the processor.

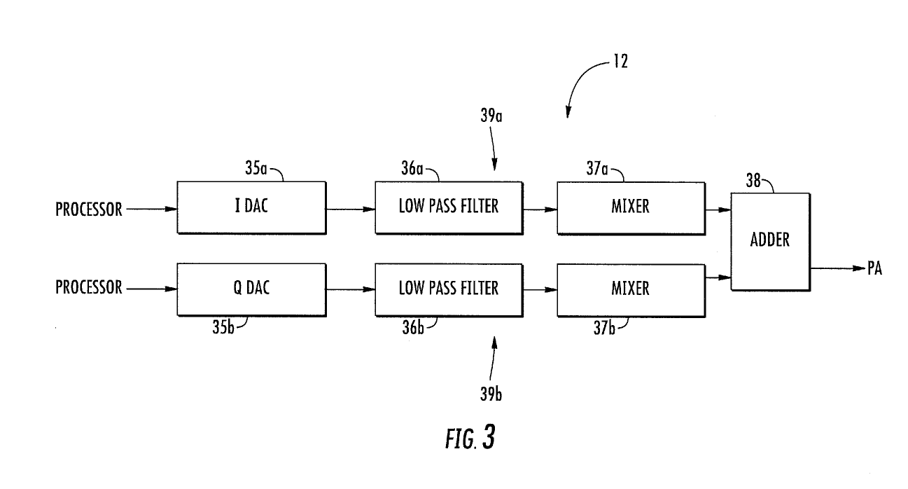

For example, the control voltage input may comprise a bias voltage input, such as a drain voltage input or collector voltage input for the power amplifier 13, and/or a transmitter automatic gain control voltage signal. In some embodiments, the modulator 12 may comprise a Quadrature amplitude modulator (QAM) (FIG. 3). The processor 11 is illustratively coupled to the control voltage input of the power amplifier 13. Once transmission starts, (Block 61), the processor 11 is configured to determine an adjacent channel leakage value based upon the feedback receiver 15 and to selectively set a control voltage for the power amplifier 13 based upon the adjacent channel leakage value (Block 63). In some embodiments, the processor 11 may be configured to selectively set a control voltage for the power amplifier 13 continuously and in real-time.

More specifically, the processor 11 may be configured to generate the adjacent channel leakage value to comprise an ACLR value, as disclosed in the W-CDMA standard, for example (Block 62). For example, the processor 11 may reduce the control voltage if the ACLR value meets communication protocol requirements, thereby reducing power consumption. Of course, this may be reversed in embodiments utilizing a logarithmic scale for ACLR.

Advantageously, the mobile wireless communications device 10 may adapt in real time to operate the power amplifier 13 more efficiently than the typical cellular device. Indeed, in the typical cellular device, the drain voltage for the power amplifier may be calibrated once at the factory using a fixed load system (e.g. 50 Ohm). The calibration results are typically stored in a lookup table in the cellular device. Of course, this does not accurately represent the ever changing environment of the actual cellular device in use, which experiences antenna load changes, output power level changes, temperature and frequency channel changes, and varying PAPR requirements. Moreover, the lookup table for the typical cellular device has a limited number of samples and a limited dynamic range, which provides sub-optimal operation of the power amplifier. Lastly, the calibration at the factory may be time consuming and difficult.

Helpfully, the mobile wireless communications device 10 monitors these conditions (i.e. antenna load, target output power level, temperature and frequency channel, and PAPR operation requirements) and selectively adjusts the control voltage of the power amplifier 13 to operate efficiently. In particular, the mobile wireless communications device 10 adjusts the control voltage based upon a threshold ACLR value, which is based upon the selected communication protocol.

Moreover, in the mobile wireless communications device 10, the power amplifier loading conditions are taken in to account while changing the power amplifier 13 control voltage for the given power needs. In good voltage standing wave ratio (VSWR) conditions, the power amplifier 13 control voltage can be reduced as compared to the typical 50 Ohm test system, giving additional savings. The mobile wireless communications device 10 does not depend on ACLR characterization for parameters, such as temperature and frequency and power level, so that a minimum possible power amplifier 13 control voltage can be used. With the mobile wireless communications device 10, the time consuming factory calibration for ACLR may be avoided. Additionally, the mobile wireless communications device 10 does not need a power detector since the feedback receiver 15 can be used to detect transmission power for a wider dynamic range, which may reduce power consumption and manufacturing cost.

In some embodiments, the processor 11 may be configured to selectively set the control voltage for the power amplifier 13 additionally based upon a received power control value, i.e. using both the adjacent channel leakage value and the receive power control value. For example, the mobile wireless communications device 10 may receive power control bit values from an associated wireless base station (not shown), and the processor 11 may use these power control bit values to set the control voltage.

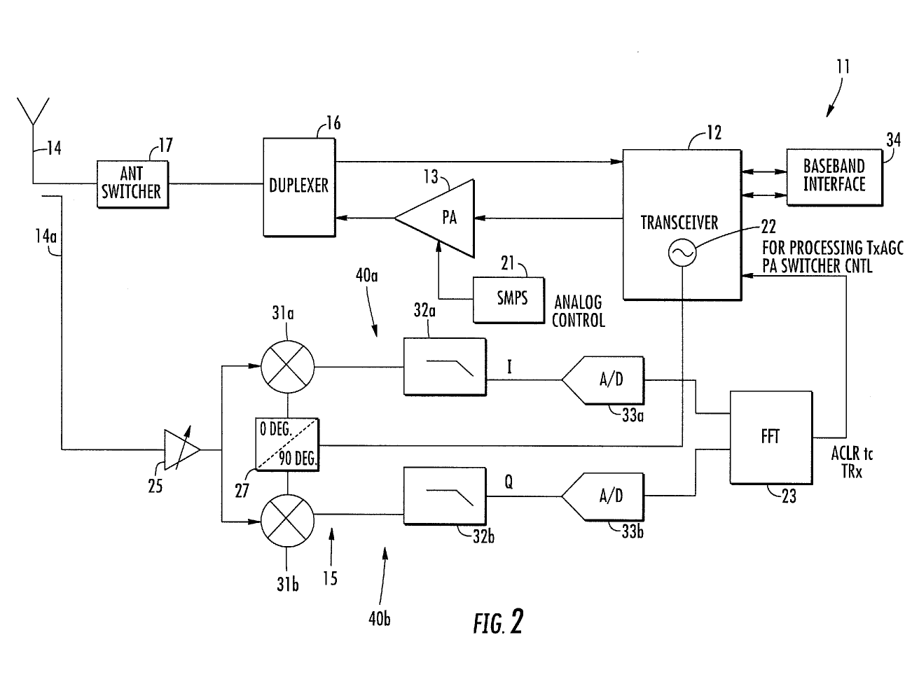

Referring additionally to FIG. 2, the mobile wireless communications device 10 further comprises a power supply (illustratively shown as a switched mode power supply) 21 cooperating with the processor 11 and the modulator (shown here as part of a transceiver block) 12, and configured to selectively generate the control voltage. The mobile wireless communications device 10 further comprises a duplexer 16 coupled downstream from the power amplifier 13, which is configured to selectively deliver signals to and from the antenna 14 to appropriate transmit and receiver paths in the transceiver 12. The mobile wireless communications device illustratively includes an antenna switch block 17 coupled between the duplexer 16 and the antenna 14. In the illustrated embodiment, the processor 11 illustratively includes a baseband interface block 34.

The feedback receiver 15 illustratively includes a directional coupler 14a coupled upstream of the antenna 14, a variable gain amplifier25 coupled to transmit path before the antenna 14, I and Q receive circuits 40a-40b coupled downstream from the filter, and a FFT block 23 coupled downstream from the I and Q receive circuits. The FFT block 23 is configured to use the data from the feedback receiver 15 to determine the adjacent channel leakage value. The feedback receiver 15 illustratively includes a variable gain amplifier 25 coupled downstream from the transmit path before antenna 14, and a phase shifter block 27 coupled between local oscillator 22 and the I and Q receive circuits 40a-40b.

The FFT block 23 is configured to calculate the FFT at adjacent channel frequency points and compare it with total power. Via this process, the ACLR can be calculated. This ACLR measurement, in addition with power control bits from the wireless base station, can be used as a control signal for changing power amplifier drain voltage and transmitter automatic gain control. The FFT block 23 does not need to generate the ACLR measurement continuously, which could reduce power efficiency of the mobile wireless communications device 10, but can generate this value based upon events with respect to power control bits so that the feedback receiver 15 circuitry can be switched off for a significant percentage of time, thereby reducing power consumption.

The mobile wireless communications device 10 illustratively includes an oscillator 22 (illustratively shown within the transceiver 12) configured to generate a local oscillator signal. The I and Q transmit 39a-39b (FIG. 3) and receive circuits 40a-40b may be configured to operate based upon the local oscillator signal. In some embodiments, the processor 11 may be configured to selectively operate the I and Q receive circuits 40a-40b in a power save mode. For example, the processor may only periodically power the I and Q receive circuits 40a-40b to conserve power.

Referring now additionally to FIG. 3, the modulator 12 illustratively includes I and Q transmit circuits 39a-39b coupled between the processor 11 and the power amplifier 13. Each of the I and Q transmit circuits 39a-39b may comprise a DAC 35a-35b, a low pass filter 36a-36b coupled to an output of the DAC, a mixer 37a-37b coupled to an output of the low pass filter, and an adder block 38 configured to sum the modulated I and Q signals for delivery to the power amplifier 13.

Another aspect is directed to a method of operating a mobile wireless communications device 10 comprising a processor 11, a modulator 12 coupled downstream from the processor, a power amplifier 13 coupled downstream from the modulator and having a control voltage input, an antenna 14 coupled downstream from the power amplifier, and a feedback receiver 15 coupled between the antenna and the processor. The method may include determining an adjacent channel leakage value based upon the feedback path 15, and selectively setting a control voltage for the power amplifier 13 based upon the adjacent channel leakage value (Block 64).

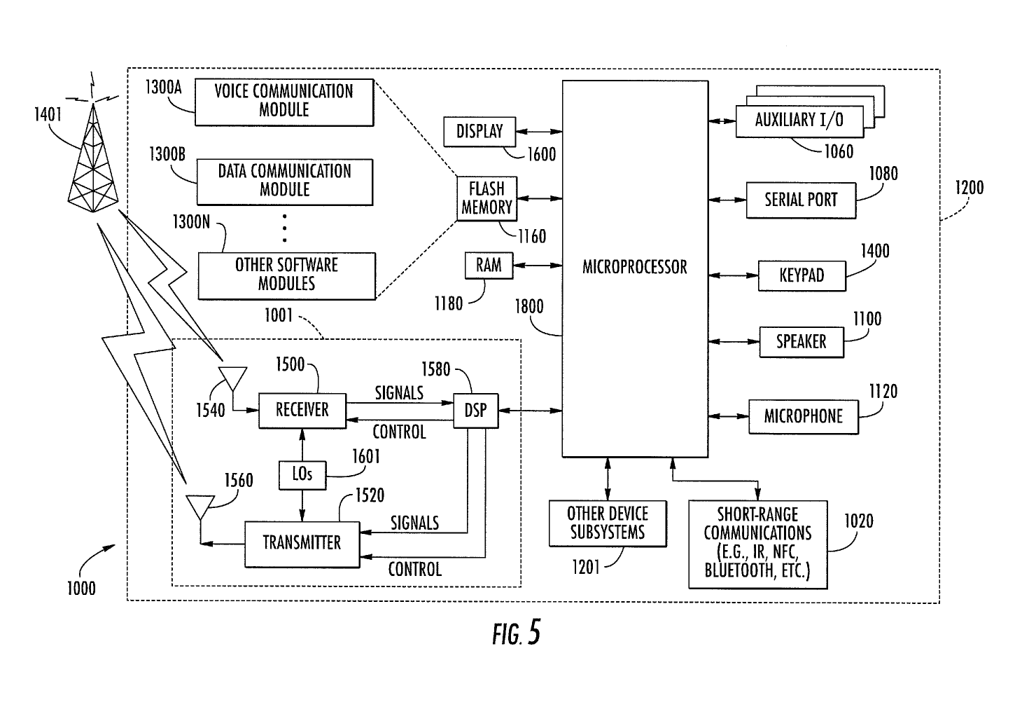

Example components of a mobile wireless communications device 1000 that may be used in accordance with the above-described embodiments are further described below with reference to FIG. 5. The device 1000 illustratively includes a housing 1200, a keyboard or keypad 1400 and an output device 1600. The output device shown is a display 1600, which may comprise a full graphic liquid crystal display (LCD). Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 5. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem 1020. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TACT™ or General Packet Radio Service (GPRS) mobile data communications networks, and also designed to operate with any of a variety of voice communications networks, such as Advanced Mobile Phone System (AMPS), time division multiple access (TDMA), code division multiple access (CDMA), Wideband code division multiple access (W-CDMA), personal communications service (PCS), GSM (Global System for Mobile Communications), enhanced data rates for GSM evolution (EDGE), etc. Other types of data and voice networks, both separate and integrated, may also be utilized with the mobile device 1000. The mobile device 1000 may also be compliant with other communications standards such as 3GSM, 3rd Generation Partnership Project (3GPP), Universal Mobile Telecommunications System (UMTS), 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a NFC sensor for communicating with a NFC device or NFC tag via NFC communications.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A mobile wireless communications device comprising:
a processor;
a modulator coupled downstream from said processor;
a power amplifier coupled downstream from said modulator and having a control voltage input;
an antenna coupled downstream from said power amplifier; and
a feedback path coupled between said antenna and said processor;
said processor coupled to the control voltage input of said power amplifier, and configured to determine an adjacent channel leakage value based upon said feedback path and to selectively set a control voltage for said power amplifier based upon the adjacent channel leakage value.

2. The mobile wireless communications device of claim 1 wherein said processor is configured to selectively set the control voltage for said power amplifier based upon a received power control value.

3. The mobile wireless communications device of claim 1 wherein the adjacent channel leakage value comprises an adjacent channel leakage ratio (ACLR) value.

4. The mobile wireless communications device of claim 1 wherein the control voltage comprises a drain/collector bias voltage for said power amplifier.

5. The mobile wireless communications device of claim 1 wherein the control voltage comprises a supply voltage.

6. The mobile wireless communications device of claim 1 further comprising a power supply cooperating with said processor and configured to selectively generate the control voltage.

7. The mobile wireless communications device of claim 1 wherein said modulator comprises In-phase (I) and Quadrature (Q) transmit circuits coupled between said processor and said power amplifier.

8. The mobile wireless communications device of claim 7 wherein each of said I and Q transmit circuits comprises a digital-to-analog converter (DAC), a low pass filter coupled to an output of said DAC, and a mixer coupled to an output of said low pass filter.

9. The mobile wireless communications device of claim 7 wherein said feedback path comprises a directional coupler coupled to upstream of said antenna, I and Q receive circuits coupled downstream from said directional coupler, and a fast Fourier transform (FFT) block coupled downstream from said I and Q receive circuits.

10. The mobile wireless communications device of claim 9 further comprising an oscillator configured to generate a local oscillator signal; and wherein said I and Q transmit and receive circuits are configured to operate based upon the local oscillator signal.

11. The mobile wireless communications device of claim 9 further comprising a variable gain amplifier coupled downstream from said directional coupler, and a phase shifter block coupled between said oscillator and said I and Q receive circuits.

12. The mobile wireless communications device of claim 9 wherein said processor is configured to selectively operate said I and Q receive circuits in a power save mode.

13. A mobile wireless communications device comprising:
a processor;
a modulator coupled downstream from said processor;
a power amplifier coupled downstream from said modulator and having a drain/collector voltage input;
an antenna coupled downstream from said power amplifier; and
a feedback path coupled between said antenna and said processor;
said processor coupled to the drain voltage input of said power amplifier, and configured to determine an adjacent channel leakage value based upon said feedback path and to selectively set a drain/collector voltage for said power amplifier based upon the adjacent channel leakage value and a received power control value.

14. The mobile wireless communications device of claim 13 wherein the adjacent channel leakage value comprises an adjacent channel leakage ratio (ACLR) value.

15. The mobile wireless communications device of claim 13 further comprising a power supply cooperating with said processor and configured to selectively generate the drain voltage.

16. The mobile wireless communications device of claim 13 wherein said modulator comprises In-phase (I) and Quadrature (Q) transmit circuits coupled between said processor and said power amplifier.

17. The mobile wireless communications device of claim 16 wherein each of said I and Q transmit circuits comprises a digital-to-analog converter (DAC), a low pass filter coupled to an output of said DAC, and a mixer coupled to an output of said low pass filter.

18. The mobile wireless communications device of claim 13 wherein said feedback path comprises a directional coupler coupled upstream of said antenna, I and Q receive circuits coupled downstream from said directional coupler, and a fast Fourier transform (FFT) block coupled downstream from said I and Q receive circuits.

19. A method of operating a mobile wireless communications device comprising a processor, a modulator coupled downstream from the processor, a power amplifier coupled downstream from the modulator and having a control voltage input, an antenna coupled downstream from the power amplifier, and a feedback path coupled between the antenna and the processor, the method comprising:
determining an adjacent channel leakage value based upon the feedback path; and
selectively setting a control voltage for the power amplifier based upon the adjacent channel leakage value.

20. The method of claim 19 further comprising selectively setting the control voltage for the power amplifier based upon a received power control value.

21. The method of claim 19 further comprising generating the adjacent channel leakage value to comprise an adjacent channel leakage ratio (ACLR) value.

22. The method of claim 19 further comprising selectively setting the control voltage to comprise a drain/collector bias voltage for the power amplifier.

23. The method of claim 19 further comprising operating a power supply with the processor to selectively generate the control voltage.

24. The method of claim 19 wherein the modulator comprises In-phase (I) and Quadrature (Q) transmit circuits coupled between the processor and the power amplifier.

25. The method of claim 24 wherein each of the I and Q transmit circuits comprises a digital-to-analog converter (DAC), a low pass filter coupled to an output of the DAC, and a mixer coupled to an output of the low pass filter.
